(19) United States
(12) Patent Application Publication
(10) Pub. No.: US 2025/0222375 A1
(43) Pub. Date: Jul. 10, 2025

(54) Device for sorting fibres by differentiated lateral displacement, use of such a device for sorting fibres and method for sorting fibres

(71) Applicants: ECOLE POLYTECHNIQUE, PALAISEAU cedex (FR); CENTRE NATIONAL DE LA RECHERCHE SCIENTIFIQUE, Paris (FR)

(72) Inventors: Ursy MAKANGA, Palaiseau (FR); Blaise DELMOTTE, Palaiseau (FR); Camille DUPRAT, Palaiseau (FR)

(21) Appl. No.: 18/881,432

(22) PCT Filed: Jul. 7, 2023
(86) PCT No.: PCT/EP2023/068908

§ 371 Date: Jan. 6, 2025

(30) Foreign Application Priority Data
Jul. 7, 2022 (FR) FR2206968

(51) Int. Cl. B01D 21/00; B01D 43/00

(52) U.S. Cl. CPC B01D 21/0042; B01D 43/00

(57) ABSTRACT

A device for sorting fibres, in particular synthetic fibres, contained in a fibre-laden liquid. The sorting device comprising-includes a container adapted to contain the liquid, and a network of obstacles arranged in the container. The obstacle network being configured so that a fibre could cross it from an upper area of the container towards a lower area of the container, so-called the recovery area, under the effect of gravity. The obstacle network is configured to induce a differentiated lateral displacement of the fibre according to its mechanical properties, so as to perform sorting of the fibres in the recovery area by deposition of the fibres at differentiated lateral positions. A use of such a device for sorting fibres, as well as a method for sorting fibres using such a device are also provided.

### CROSS-REFERENCE TO RELATED APPLICATIONS

This application is a National Stage of International Application No. PCT/EP2023/068908, having an International filing date of 7 Jul. 2023, which designated the United States of America, and which International Application was published under PCT Article 21 (2) as WO Publication No. 2024/008947, which claims priority from and the benefit of French Patent Application No. 2206968 filed on 7 Jul. 2022, the disclosures of which are incorporated herein by reference in their entireties.

### BACKGROUND

### 1. Field

The field of the disclosure is that of fibres, in particular synthetic fibres, sorting.

More specifically, the disclosure relates to a device for sorting fibres by differentiated lateral displacement of the fibres.

In particular, the disclosure finds applications in the treatment of wastewater loaded with fibres, in particular synthetic fibres. The disclosure also finds applications in the field of biology, for the characterisation of filaments derived from cytoskeletons, or the identification of pathogen agents.

### 2. Brief Description of Related Developments

Techniques for treating wastewater, such as in particular purification stations, are known from the prior art. Although these techniques allow filtering most of the impurities contained in wastewater, they do not allow filtering the smallest wastes, in particular microplastics.

Microplastics, which are defined as plastic particles with a size of smaller than 5 millimetres, are particularly harmful to the ecosystem due to dispersion thereof in watercourses, lakes, seas and oceans, and in fine integration thereof into the feed chain of animals and humans.

A particularly widespread type of microplastics in wastewater, and particularly complex to filter and sort, are synthetic fibres. Synthetic fibres end up wastewater, in particular following washing of synthetic clothes with a washing machine.

Depollution solutions, in particular for depolluting seas and oceans, are known, consisting in positioning floating barriers on the water intended to concentrate the wastes, like a funnel, in the direction of a treatment and/or storage platform for treatment.

Solutions consisting of floating treatment plants, navigating an area to be depolluted and sucking the surrounding water for treatment thereof, are also known.

The drawback of these solutions is that they only allow the treatment of the wastes located proximate to the surface of the water and proximate to the plants, and they are not suited to the treatment of the smallest microplastics.

The known solutions also have the drawback of being active sorting solutions, requiring an external energy source for operation thereof.

Finally, these solutions have the drawback of offering only an a posteriori depollution, with no pollution prevention effect.

Furthermore, in the known systems, it is necessary to proceed with sorting of the collected wastes after collection, for recycling thereof. Yet, it would be desirable to collect the wastes, in particular microplastics, and sort them simultaneously, for recycling thereof.

Moreover, solutions for sorting particles according to their length, by lateral displacement through a network of obstacles, are known, for example from the international patent application WO 2019211523 A1. In this document, sorting is performed actively, under the effect of a pressure difference induced by a pump.

Passive solutions for sorting particles according to their length are also known, for example from the American patent application US20130168298 A1. In this document, the sorting device is not designed specifically for sorting fibres.

### SUMMARY

The present disclosure aims to overcome all or some of the aforementioned drawbacks of the prior art.

To this end, the disclosure relates to a device for sorting fibres, in particular synthetic fibres, contained in a fibre-laden liquid, the sorting device comprising a container extending according to a substantially vertical direction and being adapted to contain the liquid, and a network of obstacles arranged in the container, the obstacle network being configured to be crossed by a fibre from an upper area of the container towards a lower area of the container, so-called the recovery area, under the effect of gravity, and the obstacle network comprises a plurality of substantially parallel rods, extending substantially orthogonally to said substantially vertical direction, and wherein the cross-section of a rod is triangular shaped, and wherein the orientation of a rod is such that most of the vertices of the triangular shape is closer to the upper area of the container than to the lower area of the container, whereby the obstacle network is configured to induce a differentiated lateral displacement of said fibre along the length of the fibre and/or the flexibility of the fibre, so as to perform fibre sorting in the recovery area by depositing the fibres at differentiated lateral positions.

Thus, the sorting device is entirely passive, which enables the implementation of the device without the need for an external energy source. The vertical orientation of the container in use, i.e. substantially parallel to the direction of the local gravitational field, allows ensuring a displacement of the fibres in the container under the sole effect of gravity. Hence, the vertical orientation of the device corresponds to a normal configuration of use of the device.

In particular, sorting could be performed in the device under the sole effect of gravity, and in particular in the absence of any effect of any active means for causing the fibres to cross the obstacle network.

Thanks to the obstacle network, the device allows filtering a fibre-laden liquid, as well as sorting these according to their type.

Indeed, the obstacle network is selected so as to induce a lateral displacement of the fibres which depends on their mechanical properties, i.e. which depends on the type of fibre, and herein in particular its length and/or its flexibility.

Thus, it is possible in particular to discriminate the fibres according to their length, which could be decisive for revalorisation thereof, and/or their flexibility, which is an indicator of the type of the constituent material of the fibre, which could also be decisive for revalorisation thereof.

Sorting is performed by the sole hydrodynamic interaction between the fibres and the obstacles of the obstacle network, immersed in the liquid.

Thus, a liquid initially loaded with fibres poured into the container, such as a wastewater loaded with synthetic fibres, could be filtered after a rest time enabling the fibres to move towards the bottom of the container under the effect of their own weight. After passage through the obstacle network, the fibres sorted according to their mechanical properties could be recovered at the recovery area. The sorted fibres could be revalorised, and the liquid previously loaded with fibres is filtered, and could for example be discharged into the environment without fearing a microplastic pollution.

The plurality of substantially parallel rods, extending substantially orthogonally to said substantially vertical direction, form a network of obstacles like a grid, through which the fibres can move.

The shape and the orientation of the cross-sections of the rods allows obtaining a satisfactory lateral displacement of the fibres with a moderate risk of clogging of the fibres in the network.

In addition, the sorting device has a particularly simple design, which makes it both inexpensive and simple to maintain, and easily adaptable for different applications.

According to other advantageous features:

Said triangular shape includes rounded vertices.

Such a rounded shape of the vertices contributes to reducing the risk of clogging of the fibres in the obstacle network.

Said triangular shape is isosceles, and preferably equilateral.

A base of said triangular shape is substantially parallel to a bottom that the container includes.

The obstacle network comprises a plurality of series of rods, arranged offset above one another according to said substantially vertical direction, so as to obtain a staggered arrangement of the rods according to the substantially vertical direction.

Such an arrangement has the effect of maximising the probability of a fibre encountering an obstacle, and in particular several obstacles, during movement thereof through the obstacle network. Thus, the lateral displacements could cumulate, discrimination at the outlet of the obstacle network is improved. In addition, such an arrangement promotes the movements of fibres along diagonals of the sorting network, which reinforces the total lateral displacement.

The maximum dimension of the cross-section of a rod is comprised between 0.5 and 10 times the average length of the fibres intended to be sorted.

Such a range of values represents a good trade-off between risk of clogging of the fibres in the network, and the probability for one fibre to encounter an obstacle and be moved laterally. In particular, a maximum dimension of the cross-section of a rod is comprised between 1 and 3 times the average length of the fibres intended to be sorted may be preferred, and represents an ideal trade-off.

Another object of the disclosure is a biological analysis plant comprising a sorting device as described hereinbefore, for characterising biological fibres, in particular pathogens or cytoskeletons.

Another object of the disclosure is a wastewater treatment plant comprising a treatment circuit and a device for sorting fibres, as described hereinbefore, the device being arranged downstream of said treatment circuit.

Thus, it is possible to improve the quality of the effluents treated in a wastewater treatment plant, while recovering the sorted fibres for revalorisation thereof, for example.

Another object of the disclosure is the use of a device for sorting fibres, in particular synthetic fibres, contained in a fibre-laden liquid, the sorting device comprising a container extending according to a substantially vertical direction and being adapted to contain the liquid, and a network of obstacles arranged in the container, the obstacle network being configured so as to be crossed by a fibre from an upper area of the container towards a lower area of the container, so-called the recovery area, under the effect of gravity, the obstacle network being configured to induce a differentiated lateral displacement of said fibre according to its flexibility, to sort fibres in particular according to their flexibility by deposition at differentiated lateral positions in the recovery area.

Such a use, i.e. the implementation of a method for sorting fibres by means of a sorting device as described, is unknown in the technique for sorting fibres according to their flexibility in particular.

Furthermore, sorting may be carried out according to the flexibility and the length of the fibre, together determining a characteristic behaviour of the fibre in the liquid in interaction in the obstacle network.

Sorting according to flexibility in particular allows discriminating fibres according to their constituent material for example, unlike the known technique.

In particular, sorting may be performed under the sole effect of gravity, and in particular in the absence of any effect of any active means for causing the fibres to cross the obstacle network.

According to other advantageous features:

To perform the sorting, the obstacle network is selected according to the fibres to be sorted, with the ratio of the length of the fibres to the maximum dimension of an obstacle of the obstacle network being substantially equal to 1.

This limits the risk of trapping of the fibres in the obstacle network.

To perform the sorting, the obstacle network comprises a plurality of rods selected according to the fibres to be sorted, with the maximum dimension of the cross-section of a rod which is comprised between 0.5 and 10 times the average length of the fibres intended to be sorted.

Such a range of values represents a good trade-off between risk of clogging of the fibres in the network, and the probability for one fibre to encounter an obstacle and be moved laterally.

Sorting of the fibres being performed so that the Reynolds number, characterising the behaviour of the liquid in the container, is lower than 1, preferably lower than 0.1.

Thus, a better operation of the device could be obtained, the liquid being close to rest, and the displacement of the fibre is not disturbed, which has the effect of improving the quality of sorting.

The device is used for sorting fibres contained in a fibre-laden liquid comprising water, in particular salt water.

Thus, the device is configured in particular so as to be able to contain water, for example salt water, intended to be treated. Water polluted with microplastic fibres is a type of liquid that is particularly likely to be filtered by the device.

The device is used for sorting fibres in a wastewater treatment plant or in a biological analysis plant.

Another object of the disclosure is a method for sorting fibres, in particular synthetic fibres, contained in a fibre-laden liquid, in particular according to their flexibility, comprising the steps of:
providing a sorting device comprising a container extending according to a substantially vertical direction and being adapted to contain the liquid, and a network of obstacles arranged in the container, the obstacle network being configured so as to be crossed by a fibre from an upper area of the container towards a lower area of the container, so-called the recovery area, under the effect of gravity;
introducing fibre-laden liquid into the sorting device;
letting the sorting device and the contained fibre-laden liquid rest, in order to perform under the effect of gravity sorting of fibres in particular according to their flexibility, by deposition at differentiated lateral positions in the recovery area;
recovering the fibres sorted at the recovery area.

Thus, the sorting method is passive, i.e. all it needs is to fill the container with a fibre-laden liquid, then let it rest, without any external intervention and without any intervention of an active element, so that the sorting of fibres takes place.

It should be pointed out that the container could be totally or partially filled beforehand with a liquid, in particular a liquid that is not loaded with fibres.

In particular, in the method, the sorting may be carried out under the sole effect of gravity, and in particular in the absence of any effect of any active means for causing the fibres to cross the obstacle network.

### BRIEF DESCRIPTION OF THE FIGURES

Other particular advantages, aims and features of the present disclosure will become apparent from the following non-limiting description of at least one particular aspect of the devices and methods objects of the present disclosure, with reference to the appended drawings, wherein:

FIG. 1 is a schematic representation of a sorting device according to a particular aspect, according to a sectional view.

FIG. 2 is a detail view of two obstacles of different types, according to a cross-section.

FIG. 3 is a graph illustrating the lateral displacement of a fibre for a different elasto-gravitational number Be.

FIG. 4 is a graph illustrating the lateral displacement of a fibre for different ratios between the maximum dimension of the obstacle and the length of the fibre.

FIG. 5 is a graph illustrating the lateral displacement of a fibre for different shapes of obstacles of the obstacle network.

FIG. 6 is a schematic representation of a wastewater treatment plant comprising a sorting device.

### DETAILED DESCRIPTION

The present description is given as a non-limiting example, each feature of one aspect could be advantageously combined with any other feature of any other aspect.

As of now, it should be noted that the figures are not plotted to scale.

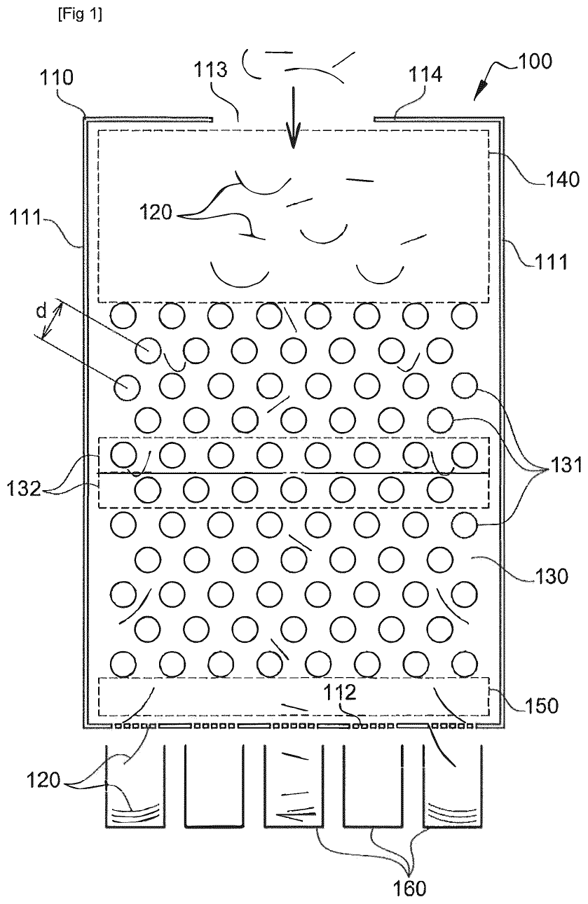

FIG. 1 schematically shows a sorting device 100 according to a possible aspect, according to a longitudinal sectional view.

The sorting device 100 comprises a container, which in particular consists of a vessel 110. The vessel 110 is adapted to contain a fibre-laden liquid 120, in particular loaded with synthetic fibres. For example, such a liquid may comprise water, and in particular a solute such as salt.

According to another possibility, the liquid may consist of silicone oil.

The vessel 110 comprises side walls 111, a bottom 112, and an opening 113 adapted to fill the vessel 110 with a liquid.

In particular, the vessel 110 comprises an upper wall 114 provided with the opening 113. Nonetheless, the opening 113 may be formed in a side wall 111.

The vessel 110 extends according to a longitudinal direction between the bottom 112 and the upper wall 114.

The height of the vessel 110, defined as being its dimension according to the longitudinal direction, is herein larger than its transverse dimensions. Nonetheless, the vessel 110 may also be wide rather than tall, in other variants.

In particular, the vessel 110 may have a rectangular base, although any other shape could also be suitable.

For example, the dimensions of a rectangular base of the vessel 110 may be 40 centimetres by 60 centimetres. For example, its height is 80 centimetres.

Next, the use of the terms “lower”, “upper” and “lateral” is made while considering a vessel 110 arranged vertically, i.e, wherein the longitudinal direction corresponds to a vertical direction of the vessel 110 in use. By “vertical” direction, it should be understood a direction substantially parallel to the local terrestrial gravitational field.

The sorting device 100 comprises a network of obstacles 130 arranged inside the vessel 110. The obstacle network 130 is configured to induce a differentiated lateral displacement of the fibres 120, according to their mechanical properties.

Preferably, the obstacle network 130 extends between an upper area 140 of the vessel 110, and a lower area 150, so-called the recovery area, of the vessel 110, and may be crossed by a fibre 120 from the upper area 140 towards the lower area 150.

More specifically, the obstacle network 130 is arranged at a distance from the bottom 112, and at a distance from the upper wall 114.

Preferably, the obstacle network 130 extends substantially from one side wall 111 to another, while being substantially parallel to the bottom 112.

The obstacle network 130 comprises a plurality of obstacles.

In particular, the obstacles consist of solid or hollow rods 131. Preferably, the rods 131 are rectilinear.

The rods 131 extend substantially parallel to one another, in a transverse direction of the vessel 110, which is in particular orthogonal to the longitudinal direction of the vessel 110. In other words, the rods 131 are arranged substantially parallel to the bottom 112.

As shown in FIG. 1, the rods 131 may be arranged according to a plurality of series 132 of rods, the series 132 being arranged offset above one another according to the longitudinal direction of the vessel 110.

Thus, a staggered arrangement of the rods 131 according to the vertical direction is obtained.

For example, the obstacle network 130 comprises between five and fifteen, preferably ten, series 132 of rods.

For example, each series 132 of rods comprises between five and ten rods 131.

For example, the distance d between two adjacent rods 131 belonging to two different series corresponds to between 1 and 2 times, preferably 1.5 times, the maximum dimension of the cross-section of a rod 131.

According to a first variant, a cross-section of a rod 131 is circular shaped.

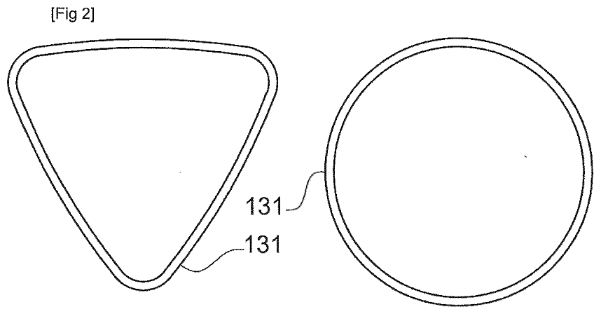

Such a configuration is shown to the right in FIG. 2, which shows the cross-sections of two variants of rods 131.

According to a second variant, a cross-section of a rod 131 is polygonal shaped.

Preferably, the polygonal shape of a rod section 131 is a triangular shape. In particular, the triangular shape is isosceles, preferably equilateral.

Also preferably, the polygonal shape of a rod 131 section includes rounded or blunt vertices.

A particularly preferred configuration is a rod 131 section with a triangular shape, whose vertices are rounded, as shown to the left in FIG. 2.

The triangular shape with rounded vertices is not limited to the representation made in FIG. 2. Indeed, any triangle shape from almost a circle to a “conventional” triangle, may be considered. In other words, the vertices of the triangular shape may be from slightly rounded to very substantially rounded.

When the cross-section of a rod 131 has a triangular shape, the orientation of a rod 131 is preferably such that most of the vertices of the triangular shape are closer to the upper area 140 of the vessel 110, i.e. of the upper wall 114, than the lower area 150 of the vessel 110, i.e. the bottom 112.

In other words, such an orientation of a rod 131 corresponds to a triangular shape whose cross-section “points” towards the lower area 150.

Preferably, in such an orientation, a base of the triangular shape of the cross-section of a rod 131 is substantially parallel to the bottom 112, being oriented in opposition to the latter.

In particular, when the triangular shape of the cross-section of a rod 131 is isosceles, the base is oriented towards the upper wall 114.

The dimensions of a cross-section of a rod 131 are selected according to the type of fibres 120 to be sorted. In particular, the maximum dimension of the cross-section of a rod 131 is comprised between 0.5 and 10 times, preferably between 1 and 3 times, the average length of the fibres 120 intended to be sorted. Such a dimension allows reducing the risk of clogging of the fibres 120 in the obstacle network 130, and maximises their reorientation.

In other words, the dimensions of the cross-section depend on the application intended for the sorting device 100.

For example, the fibres 120 are in the range of one centimetre or of one millimetre in the case of synthetic fibres in a wastewater, and in the range of one micrometre in the case of fibrous biological organisms.

In the case of a circular section, the maximum dimension of the cross-section corresponds to its diameter, whereas for a triangular shaped section, the maximum dimension of the cross-section corresponds to the length of its base.

After passage in the obstacle network 130, the fibres 120 can be recovered directly in the recovery area 150, following deposition thereof at differentiated lateral positions on the bottom 112, or indirectly downstream of the recovery area 150.

In the latter case, the sorting device 100 may also comprise units 160 for recovering fibres 120, as shown in FIG. 1.

For example, recovery units 160 in the form of containers are arranged proximate to the bottom 112, inside or outside the vessel 110.

Thus, the recovery units 160 allow easily collecting and recovering the sorted fibres 120.

The sorting device 100 functions as described hereinafter.

The vessel 110 is filled with a fibre-laden liquid 120, which is intended to be filtered and whose fibres 120 are intended to be sorted.

As indicated hereinbefore, the liquid may, for example, comprise water. The liquid may also comprise a solute such as salt, i.e. the liquid comprises salt water, such as seawater.

In general, the liquid is a liquid polluted by fibres 120, which consist in particular of synthetic fibres. The synthetic fibres may originate from human activities, such as washing of clothes made of synthetic material.

In particular, the synthetic fibres contained in the liquid comprise in particular polyester, polyolefin, acrylic, nylon fibres.

Preferably, the vessel 110 is filled beforehand with an identical or different liquid, so as to at least immerse the obstacle network 130.

Indeed, fibres sorting is preferably performed when the liquid contained in the vessel 110 is almost at rest.

In other words, the Reynolds number, characterising the behaviour of the liquid in the vessel 110, is lower than 1, preferably comprised between 0.1 and 10⁻⁶.

More specifically, the Reynolds number could herein be defined as follows:

$$Re = \frac{ρ \cdot U \cdot l}{η} ,$$

where U is the speed of the fibre 120, given by the equilibrium between gravity and the viscosity of the liquid, l is the average length of a fibre, ρ is the density of the fluid and η is the dynamic viscosity of the liquid.

Thus, not only the flow of the liquid is laminar, it is preferably quasi-static, i.e. the fluid is substantially at rest.

Thus, one could understand that in order to maintain a constant Reynolds number for different fibre lengths, to obtain a constant operation of the sorting device 100, all it needs is to modify the viscosity of the liquid. For example, for fibres 120 with a length shorter than 100 micrometres, water may be used, whereas for fibres with a length longer than 100 micrometres, oil, in particular silicone oil, may be used.

The fibres 120 contained in the liquid move under the effect of their own weight towards the bottom 112 of the vessel 110. To obtain such a behaviour, the vessel 110 is arranged substantially vertically, in accordance with what has been described further upstream.

During movement thereof towards the bottom 112, the fibres 120 encounter the obstacles of the obstacle network 130.

Each fibre 120 has specific mechanical properties. In particular, these mechanical properties include geometric characteristics of the fibre 120, such as its length, and intrinsic mechanical properties, such as its flexibility, expressed in particular by its Young's modulus.

It has been observed that the hydrodynamic interactions between an obstacle such as a rod 131 and a fibre 120 induce a lateral displacement of the fibre 120 upon passage thereof through the obstacle network 130.

More specifically, it has been observed that the more a fibre 120 is long and/or not very flexible, the more the latter drifts laterally.

In other words, the lateral displacement of a fibre 120 is inversely proportional to the elasto-gravitational adimensional number Be of the fibre, defined as follows:

$$Be = \frac{{WL}^{3}}{EI} ,$$

where W is the linear mass of the fibre, L is the length of the fibre, E is the Young's modulus of the fibre, and/is the quadratic moment of the fibre.

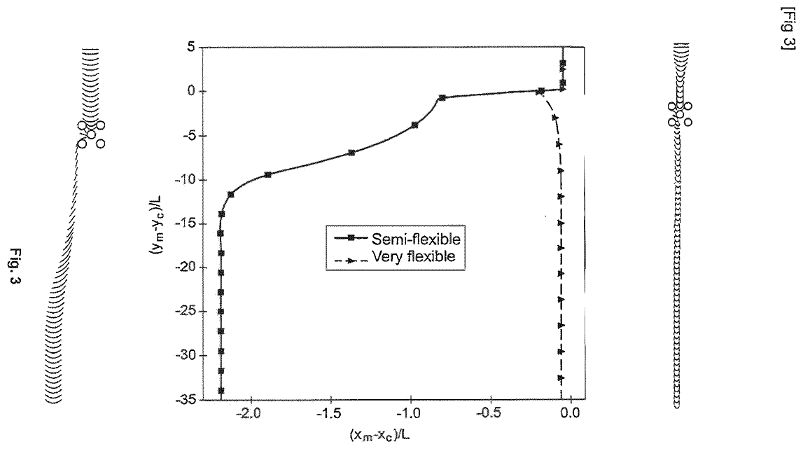

FIG. 3 is a graphical representation of the lateral displacement of a fibre 120 for an elasto-gravitational number equal to 200 (chronophotography to the left and plot ▪) as well as for an elasto-gravitational number equal to 1,000 (chronophotography to the right and plot [symbol] ). The ratio between the length of the fibre 120 and the maximum dimension of an obstacle of the obstacle network 130 (also denoted ξ) herein corresponds to 2. The obstacles have a circular section.

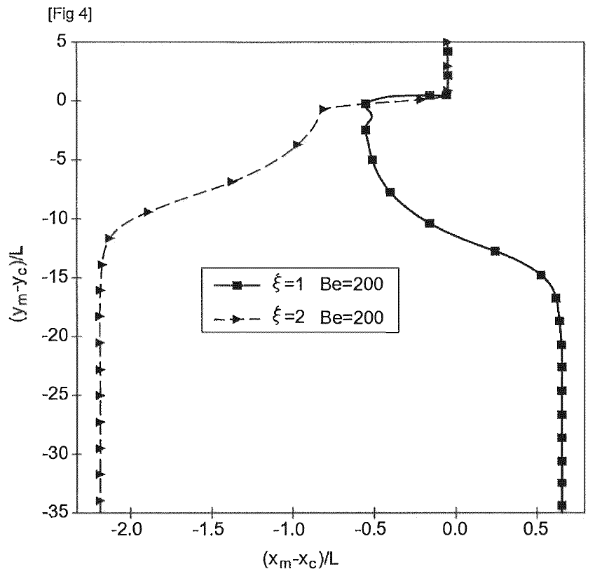

FIG. 4 is a graphical representation of the lateral displacement of a fibre 120 for an elasto-gravitational number equal to 200, for a ratio between the length of the fibre 120 and the maximum dimension of an obstacle of the obstacle network 130 of 1 (plot ▪) as well as for a ratio between the length of the fibre 120 and the maximum dimension of an obstacle of the obstacle network 130 of 2 (plot [symbol] ). The obstacles have a circular section.

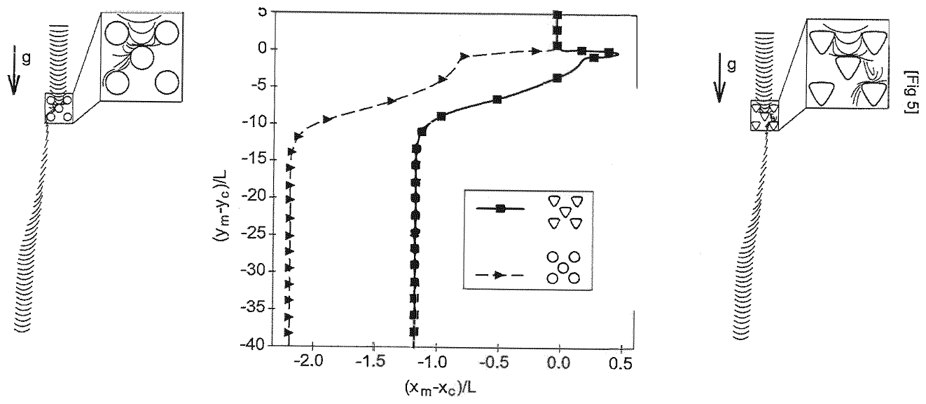

Respectively in the graphs of FIGS. 3 and 4, as well as in FIG. 5 described below, the depth position of the centre of mass of the fibre 120 in the vessel 110, normalised by the length of the fibre 120, is indicated on the ordinate axis. The lateral position of the centre of mass of the fibre 120 in the vessel 110, also normalised by the length of the fibre 120, is indicated on the abscissa axis.

As it clearly appear from the comparison between the plot of the “semi-flexible” fibre (Be=200) and that of a “very flexible” fibre (Be=1,000), a fibre 120 for which the elasto-gravitational number is low, the fibre 120 will tend to move laterally in a substantial manner (in the range of several times the length of the fibre, at the end of passage thereof in the obstacle network), whereas for a fibre 120 for which the elasto-gravitational number is high, the fibre 120 will barely tend to move laterally.

Thus, the most rigid fibres 120 move laterally in a substantial manner, and are substantially separated from a central position in the vessel 110 at the end of passage thereof through the obstacle network 130, as it also appears from the chronophotographies of FIG. 3.

On the contrary, the most flexible fibres 120 barely move laterally, and remain substantially at the central position in the vessel 110 at the end of passage thereof through the obstacle network 130.

Thus, the obstacle network 130 allows inducing a differentiated lateral displacement of the fibres 120, for sorting, or discrimination, thereof according to mechanical properties.

As shown in FIG. 4, a ratio between the length of the fibre 120 and the maximum dimension of an obstacle of the high obstacle network 130, i.e. a large fibre size, induces a greater lateral displacement.

Of course, the more a fibre 120 encounters obstacles, the more its lateral displacement will be amplified at the end of passage through the obstacle network 130. Thus, it is advantageous to provide for a plurality of series of obstacles arranged according to the longitudinal direction, advantageously in a staggered manner, as has been set out further upstream, so as to maximise the encounter of obstacles by a fibre.

In addition, the selection of a particular cross-section of the rods 131 of the obstacle network 130 allows varying the behaviour of the sorting device 100.

FIG. 5 is a graphical representation of the lateral displacement of a fibre 120 for obstacles with a circular cross-section (chronophotography to the left and plot [symbol] ) as well as for obstacles with a rounded triangular cross-section, oriented towards the bottom of the vessel (chronophotography to the right and plot ▪). The ratio between the length of the fibre 120 and the maximum dimension of an obstacle of the obstacle network 130 herein corresponds to 2. The obstacles have a circular section. The elasto-gravitational number is equal to 200.

As it clearly appears from FIG. 5, a circular cross-section shape induces the greater lateral displacement of a fibre 120 in comparison with a triangular shape with rounded vertices, for a constant elasto-gravitational number.

It should be noted that a triangular shape with concave sides (not shown) could allow inducing a greater lateral displacement of a fibre 120. Thus, the selection of such a shape could be made in order to amplify the lateral displacement, yet it nonetheless involves a risk of trapping of the fibre in the obstacle network, in particular in the case of long and flexible fibres which might remain blocked on a vertex of the triangular shape. In addition, the stay time of the fibre 120 in the obstacle network 130 is then increased.

In general, in order to minimise the risk of clogging and the stay time, the ratio between the length of the fibre 120 and the maximum dimension of an obstacle of the obstacle network 130 may be selected in the vicinity of 1. Indeed, long fibres tend to be blocked on the obstacles 131.

In order to minimise the risk of trapping of the fibres 120 by friction, the orientation of the obstacles may be selected such that most of the vertices of the triangular shape of the section of the obstacle are closer to the lower area 150 of the vessel 110 than the upper area 140 of the vessel 110, in other words the triangular shape “points” towards the upper portion.

In order to minimise the risk of trapping of the fibres 120 by clogging, the orientation of the obstacles may be selected such that most of the vertices of the triangular shape of the section of the obstacle are closer to the upper area 140 of the obstacle vessel 110 than the lower area 150 of the vessel 110, in other words the triangular shape does not “points” towards the lower portion.

Also, the surface roughness of the obstacles of the obstacle network 130 may be reduced in order to minimise the risk of trapping of the fibres 120 by friction.

Thus, one could understand that the size of the obstacles of the obstacle network 130 compared to the average size of the fibres to be sorted, the shape of their cross-section, the orientation of their cross-section, as well as their number in the obstacle network 130, are design parameters of the sorting device 100 which could be adjusted in order to adapt the device to the considered application.

In order to illustrate the possibilities of application of the sorting device 100, two examples are given hereinafter.

### Example of a First Particular Application

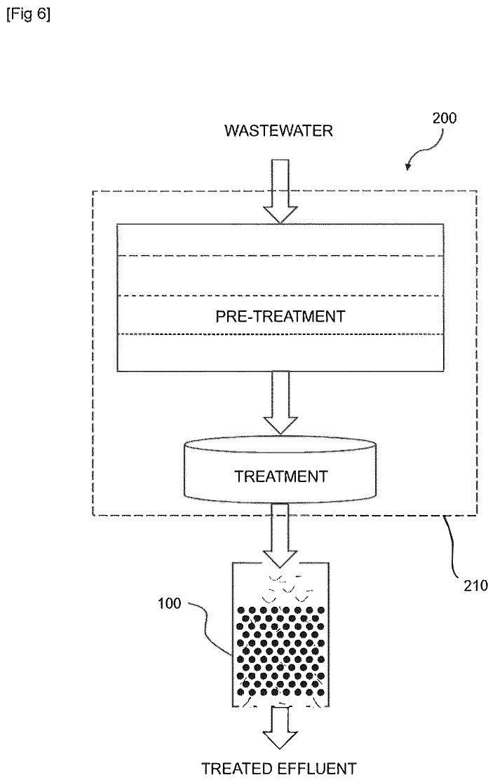

A wastewater treatment plant 200, such as a purification plant, is schematically illustrated in FIG. 6.

The treatment plant 200 comprises a wastewater treatment circuit 210, which may for example comprise a pretreatment station intended to separate the large-size solid elements, sediments and fats from wastewater. In general, such a circuit 210 then comprises biological treatment basins, and clarifiers.

The treatment plant 200 may comprise a sorting device 100, preferably downstream of the treatment circuit 210. Indeed, it is preferable to filter a water that has already been purified to a large extent, so that the sorting device 100 could make an effect under optimum conditions.

Thus, the effluents treated at the outlet of the treatment plant 200 are depolluted and no longer include fibres, in particular synthetic fibres, or include few.

Thus, the integration of a sorting device 100 into a treatment plant 200 allows improving the treatment of the wastewater the closest to the pollution source, in a preventive way before any pouring into the environment, and in a completely passive manner.

In such an application, the order of magnitude of the fibres is millimetric. In accordance with what has been set out further upstream, the dimensions of the obstacles of the obstacle network 130, and their spacing, are then selected in this same order of magnitude.

### Example of a Second Particular Application

According to another example of application, a biological analysis plant may comprise a sorting device 100 for characterising biological fibres, in particular pathogens or filaments derived from cytoskeletons.

A given number of pathogen agents may be assimilated to fibres from a mechanical perspective, such that a discrimination of these according to their mechanical properties could be used for characterisation or identification purposes.

For example, it is known that parasites carrying diseases such as meningitis or pneumonia develop in the form of chains of cells of various lengths and rigidities, which vary depending on whether they are dead or living, virulent or not, under the action of antibiotics or not. The application of the sorting device 100 allows separating a culture of pathogens into sub-populations discriminated according to their morphology, allowing, for example, studying their virulence.

A similar application could be made to characterise or identify cytoskeletons, which are usually in a filamentous form.

A biological analysis plant of this type essentially comprises a sorting device 100, as well as any other means necessary for the analyses to be carried out, like for example means for guaranteeing the sterility of the plant.

In such an application, the order of magnitude of the agents and cytoskeletons that could be assimilated to fibres 120 micrometric. In accordance with what has been set out further upstream, the dimensions of the obstacles of the obstacle network 130, and their spacing, are then selected in this same order of magnitude.

Another object of the disclosure is the use of a sorting device 100 for sorting fibres 120 as described hereinbefore.

In particular, the device 100 may be used in a biological analysis plant or a wastewater treatment plant 200, or any other plant or system type.

Another object of the disclosure is a method for sorting fibres (120), in particular synthetic fibres, contained in a fibre-laden liquid, sorting consisting in sorting according to the flexibility of the fibres in particular.

The method comprises the step of providing a sorting device 100, for example as described before.

For example, the device 100 comprises a container 110 extending according to a substantially vertical direction and being adapted to contain the liquid, and a network of obstacles 130 arranged in the container 110, the obstacle network 130 being configured so as to be able to be crossed by a fibre 120 from an upper area 140 of the container towards a lower area 150 of the container, so-called the recovery area, under the effect of gravity.

Afterwards, the method comprises the step of introducing the fibre-laden liquid into the sorting device 100, i.e. into the container 110.

For example, the fibre-laden liquid may be a liquid polluted by synthetic fibres.

Beforehand, it is possible that the container 110 has been filled with liquid, for example free of fibres, entirely or partially, and for example at least so as to cover the obstacle network 130.

Afterwards, the method comprises the step of letting the sorting device 100 and the contained fibre-laden liquid rest, in order to perform under the effect of gravity a sorting of fibres 120, in particular according to their flexibility, by deposition at differentiated lateral positions in the recovery area.

The step of letting the device and the liquid rest could last from a few minutes to a few hours or days, depending on the type of liquid and fibres in particular.

Preferably, the step of letting the device and the liquid rest is a step during which no active, external or internal, intervention is carried out. Only the effect of gravity is enough to perform sorting of fibres, which move towards the bottom of the container 110 under the effect of their weight while moving laterally, which has the effect of performing a sorting of the fibres 120.

Afterwards, the method comprises the step of recovering the sorted fibres 120 at the recovery area.

Thus, the fibres 120, for example synthetic fibres, could for example be recycled, or simply separated from the liquid which is thus depolluted.

The recovery of a given type of fibres at a given lateral position at the recovery area could also be used to indicate the type of pollution to which the liquid is exposed.

In another application, the fibres may consist of biological fibres, and may be characterised according to the performed sorting.

More generally, it should be recalled that the disclosure is not limited to the described and illustrated examples.

What is claimed is:

1. A device for sorting fibres, in particular synthetic fibres, contained in a fibre-laden liquid, the sorting device comprising a container extending according to a substantially vertical direction and being adapted to contain the liquid, and a network of obstacles arranged in the container, the obstacle network being configured to be crossed by a fibre from an upper area of the container towards a lower area of the container, so-called the recovery area, under the effect of gravity, characterised in that the obstacle network comprises a plurality of substantially parallel rods, extending substantially orthogonally to said substantially vertical direction, and wherein the cross-section of a rod is triangular shaped, and wherein the orientation of a rod is such that most of the vertices of the triangular shape is closer to the upper area of the container than to the lower area of the container, whereby the obstacle network is configured to induce a differentiated lateral displacement of said fibre along the length of the fibre and/or the flexibility of the fibre, so as to perform fibre sorting in the recovery area by depositing the fibres at differentiated lateral positions.

2. The device according to claim 1, wherein said triangular shape includes rounded vertices.

3. The device according to claim 1, wherein said triangular shape is isosceles, and preferably equilateral.

4. The device according to claim 1, wherein a base of said triangular shape is substantially parallel to a bottom that the container includes.

5. The device according to claim 1, wherein the obstacle network comprises a plurality of series of rods, arranged offset above one another according to said substantially vertical direction, so as to obtain a staggered arrangement of the rods according to the substantially vertical direction.

6. The device according to claim 1, wherein the maximum dimension of the cross-section of a rod is comprised between 0.5 and 10 times the average length of the fibres intended to be sorted.

7. A biological analysis plant comprising a device according to claim 1 for characterising biological fibres, in particular pathogens or filaments derived from cytoskeletons.

8. A wastewater treatment plant comprising a treatment circuit and a device according to claim 1 arranged downstream of said treatment circuit.

9. A use of a device for sorting fibres, in particular synthetic fibres, contained in a fibre-laden liquid, the sorting device comprising a container extending according to a substantially vertical direction and being adapted to contain the liquid, and a network of obstacles arranged in the container, the obstacle network-being configured so as to be crossed by a fibre from an upper area of the container towards a lower area of the container, so-called the recovery area, under the effect of gravity, the obstacle network being configured to induce a differentiated lateral displacement of said fibre according to its flexibility, to sort fibres in particular according to their flexibility by deposition at differentiated lateral positions in the recovery area.

10. The use of a device for sorting fibres according to claim 9, the obstacle network being selected according to the fibres to be sorted, with the ratio of the length of the fibres to the maximum dimension of an obstacle of the obstacle network being substantially equal to 1.

11. The use of a device for sorting fibres according to claim 9, the obstacle network comprising a plurality of rods selected according to the fibres to be sorted, with the maximum dimension of the cross-section of a rod which is comprised between 0.5 and 10 times the average length of the fibres intended to be sorted.

12. The use of a device for sorting fibres according to claim 9, sorting of the fibres being performed so that the Reynolds number, characterising the behaviour of the liquid in the container, is lower than 1, preferably lower than 0.1.

13. The use of a device for sorting fibres according to claim 9, for sorting fibres contained in a fibre-laden liquid comprising water, in particular salt water.

14. The use of a device for sorting fibres according to claim 9, in a wastewater treatment plant or in a biological analysis plant.

15. A method for sorting fibres, in particular synthetic fibres, contained in a fibre-laden liquid, in particular according to their flexibility, comprising the steps of:
providing a sorting device comprising a container extending according to a substantially vertical direction and being adapted to contain the liquid, and a network of obstacles arranged in the container, the obstacle network being configured so as to be crossed by a fibre from an upper area of the container towards a lower area of the container, so-called the recovery area, under the effect of gravity;
introducing fibre-laden liquid into the sorting device;
letting the sorting device and the contained fibre-laden liquid rest, in order to perform under the effect of gravity sorting of fibres in particular according to their flexibility, by deposition at differentiated lateral positions in the recovery area;
recovering the fibres sorted at the recovery area.
